(19) United States
(12) Patent Application Publication
(10) Pub. No.: US 2021/0358011 A1
(43) Pub. Date: Nov. 18, 2021

(54) METHOD OF OPERATING A SMART SHOPPING TERMINAL FOR A SHOPPING CART, SMART SHOPPING TERMINAL, METHOD OF MANAGING A SMART SHOPPING TERMINAL FOR A SHOPPING CART, AND SERVER

(71) Applicant: BOE TECHNOLOGY GROUP CO., LTD., Beijing (CN)

(72) Inventors: Fan Yang, Beijing (CN); Pengpeng Feng, Beijing (CN); Xiao Zhang, Beijing (CN); Xin Wang, Beijing (CN); Xuelin Han, Beijing (CN)

(21) Appl. No.: 16/483,408

(22) PCT Filed: Feb. 1, 2019
(86) PCT No.: PCT/CN2019/074453

§ 371 Date: Aug. 2, 2019

(30) Foreign Application Priority Data
Jul. 2, 2018 (CN) 201810708487.7

(51) Int. Cl. G06Q 30/06; G06Q 20/10; G06Q 20/22

(52) U.S. Cl. CPC G06Q 30/0633; G06Q 30/0613; G06Q 20/22; G06Q 20/102

(57) ABSTRACT

The present disclosure discloses a method of operating a smart shopping terminal for a shopping cart, a smart shopping terminal, a method of managing a smart shopping terminal for a shopping cart, and a server. The method of operating a smart shopping terminal for a shopping cart comprises: forming, by a first smart shopping terminal corresponding to the shopping cart, a shopping group comprising at least the first smart shopping terminal and a second smart shopping terminal corresponding to another shopping cart; and sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal.

### CROSS-REFERENCE TO RELATED APPLICATION(S)

This application is a U.S. National Phase Application of International Application No. PCT/CN2019/074453, filed on Feb. 1, 2019, entitled “Method of operating a smart shopping terminal for a shopping cart, smart shopping terminal, method of managing a smart shopping terminal for a shopping cart, and server,” which claims priority to Chinese Application No. 201810708487.7, entitled “Shopping cart interaction method, apparatus and electronic device” and filed on Jul. 2, 2018, both of which are incorporated herein by reference in their entirety.

### TECHNICAL FIELD

The present disclosure relates to the field of smart shopping carts, and in particular to a method of operating a smart shopping terminal for a shopping cart, a smart shopping terminal, a method of managing a smart shopping terminal for a shopping cart, and a server.

### BACKGROUND

With the improvement of people's living standards, the number of shopping in the supermarket has increased, and customer's requirements for shopping experience are increasing. To this end, smart terminals can be installed on shopping carts, and the automatic navigation of the shopping carts, the intelligent quick settlement payment and the like can be realized through the smart terminals. However, when family members or friends go to the supermarket for shopping together, and use different shopping carts to enter different areas and shop separately, the shopping carts used by family members or friends cannot interact with each other, and information sharing is impossible, which reduces the shopping pleasure and efficiency.

### SUMMARY

In order to solve or at least partially alleviate the above problems, some embodiments of the present disclosure propose a method of operating a smart shopping terminal for a shopping cart, a smart shopping terminal, a method of managing a smart shopping terminal for a shopping cart, and a server.

The embodiments of the present disclosure propose a method of operating a smart shopping terminal for a shopping cart. The method comprises: forming, by a first smart shopping terminal corresponding to the shopping cart, a shopping group comprising at least the first smart shopping terminal and a second smart shopping terminal corresponding to another shopping cart; and sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal.

In some embodiments, the forming, by a first smart shopping terminal corresponding to the shopping cart, a shopping group comprising at least the first smart shopping terminal and a second smart shopping terminal corresponding to another shopping cart comprises: creating the shopping group at the first smart shopping terminal; sending, to the second smart shopping terminal, a request for joining the shopping group; and receiving a response indicating whether the second smart shopping terminal is to join the shopping group.

In some embodiments, the sending, to the second smart shopping terminal, a request for joining the shopping group comprises: sending, to a server, a request to invite the second smart shopping terminal to join the shopping group, and the receiving a response indicating whether the second smart shopping terminal is to join the shopping group comprises: receiving, from the server, a response indicating whether the second smart shopping terminal is to join the shopping group.

In some embodiments, the forming, by a first smart shopping terminal corresponding to the shopping cart, a shopping group comprising at least the first smart shopping terminal and a second smart shopping terminal corresponding to another shopping cart comprises: receiving a request for joining a shopping group from the second smart shopping terminal or a server; and based on a user operation at the first smart shopping terminal, sending, to the second smart shopping terminal or the server, a response indicating whether the first smart shopping terminal is to join the shopping group.

In some embodiments, the request for joining the shopping group is generated based on identification information of the second smart shopping terminal.

In some embodiments, the identification information of the second smart shopping terminal is obtained by at least one of: entering the identification information of the second smart shopping terminal at the first smart shopping terminal; scanning and identifying the identification information of the second smart shopping terminal by the first smart shopping terminal; and obtaining a smart shopping terminal list on the server, and selecting the identification information of the second smart shopping terminal in the smart shopping terminal list.

In some embodiments, the shopping status update information is shopping list update information, and the sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal comprises: receiving, from the second smart shopping terminal, second shopping list update information corresponding to the second smart shopping terminal, sending, to the second smart shopping terminal, first shopping list update information corresponding to the first smart shopping terminal, and updating the shopping lists according to the first shopping list update information and the second shopping list update information.

In some embodiments, the method further comprises: receiving, from the second smart shopping terminal, a shopping list update request, determining corresponding shopping list update information according to the shopping list update request; and sending, to the second smart shopping terminal, the shopping list update information.

In some embodiments, the method further comprises: determining whether the shopping lists have same and/or similar items; in response to determining that the same and/or similar items are present in the shopping lists, determining whether the items are available from different smart shopping terminals; and in response to determining that the items are available from different smart shopping terminals, outputting a prompt indicating presence of the same or similar items in the shopping lists.

In some embodiments, the determining whether the shopping lists have same and/or similar items comprises: obtaining, according to the shopping lists, item identification information of the items therein, and determining, according to the item identification information, whether the shopping lists have the same items; and/or obtaining, according to the shopping lists, basic item information of the items therein, wherein the basic item information comprises item name and/or item use, and determining, according to the basic item information, whether the shopping lists have similar items.

In some embodiments, the shopping status update information is geographic location update information, and the sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal comprises: receiving, from the second smart shopping terminal, second geographic location update information corresponding to the second smart shopping terminal, sending, to the second smart shopping terminal, first geographic location update information corresponding to the first smart shopping terminal, and outputting, according to the first geographic location update information and the second geographic location update information, indication information indicating a geographical location of the second smart shopping terminal relative to the first smart shopping terminal.

In some embodiments, the shopping status update information is payment list update information, and the sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal further comprises: receiving, from the second smart shopping terminal, second payment list update information corresponding to the second smart shopping terminal; sending, to the second smart shopping terminal, first payment list update information corresponding to the first smart shopping terminal; and updating payment lists based at least on the first payment list update information and the second payment list update information.

In some embodiments, the method further comprises: making payment based on the payment lists.

In some embodiments, the method further comprises at least one of: releasing or exiting the shopping group after the payment is completed at the first smart shopping terminal; and releasing or exiting the shopping group in response to receiving, from the second smart shopping terminal, a message indicating that the payment has been completed.

According to another aspect of the present disclosure, a smart shopping terminal for a shopping cart is proposed. The smart shopping terminal comprises: a processor; and a memory communicatively coupled to the processor, the memory storing instructions executable by the processor, the instructions, when executed by the processor, causing the processor to perform the methods as described above.

According to another aspect of the present disclosure, a method of managing a smart shopping terminal for a shopping cart is proposed. The method comprises: forming, at a server, a shopping group comprising at least a first smart shopping terminal corresponding to a first shopping cart and a second smart shopping terminal corresponding to a second shopping cart; receiving, at the server, from the first smart shopping terminal and/or the second smart shopping terminal, shopping status update information associated with the respective shopping cart; and sending, at the server, to the second smart shopping terminal, shopping status update information for the shopping cart corresponding to the first smart shopping terminal and/or sending, at the server, to the first smart shopping terminal, shopping status update information for the shopping cart corresponding to the second smart shopping terminal.

In some embodiments, the forming, at a server, a shopping group comprising at least a first smart shopping terminal corresponding to a first shopping cart and a second smart shopping terminal corresponding to a second shopping cart comprises: receiving, from the first smart shopping terminal, a request instructing the second smart shopping terminal to join the shopping group; sending the request to the second smart shopping terminal; receiving, from the second smart shopping terminal, a response indicating whether the second smart shopping terminal is to join the shopping group; and sending the response to the first smart shopping terminal.

In some embodiments, the forming, at a server, a shopping group comprising at least a first smart shopping terminal corresponding to a first shopping cart and a second smart shopping terminal corresponding to a second shopping cart comprises: creating a shopping group at the server; sending a request for joining the shopping group to the first smart shopping terminal and the second smart shopping terminal; and receiving, from the first smart shopping terminal and the second smart shopping terminal, respectively, responses indicating whether the respective smart shopping terminals are to join the shopping group.

In some embodiments, the request for joining the shopping group is generated based on identification information of the first smart shopping terminal and the second smart shopping terminal.

In some embodiments, the identification information of the first smart shopping terminal and the second smart shopping terminal is obtained by at least one of: entering, at the server, the identification information of the first smart shopping terminal and the second smart shopping terminal; scanning and identifying, by a scanner communicatively coupled to the server, the identification information of the first smart shopping terminal and the second smart shopping terminal; and selecting the identification information of the first smart shopping terminal and the second smart shopping terminal from a smart shopping terminal list on the server.

In some embodiments, the shopping status update information is shopping list update information, and the receiving, at the server, from the first smart shopping terminal and/or the second smart shopping terminal, shopping status update information associated with the respective shopping cart comprises: receiving, from the first smart shopping terminal and/or the second smart shopping terminal, first shopping list update information corresponding to the first smart shopping terminal and/or second shopping list update information corresponding to the second smart shopping terminal, respectively, wherein the sending, at the server, to the second smart shopping terminal, shopping status update information for the shopping cart corresponding to the first smart shopping terminal and/or sending, at the server, to the first smart shopping terminal, shopping status update information for the shopping cart corresponding to the second smart shopping terminal comprises: sending, to the first smart shopping terminal and/or the second smart shopping terminal, the second shopping list update information and/or the first shopping list update information, respectively.

In some embodiments, the method further comprises: determining whether the shopping lists have same and/or similar items according to the first shopping list update information and the second shopping list update information; in response to determining that the same and/or similar items are present in the shopping lists, determining whether the items are available from different smart shopping terminals; and in response to determining that the items are available from different smart shopping terminals, outputting, to the first smart shopping terminal and/or the second smart shopping terminal, a prompt indicating presence of the same or similar items in the shopping lists.

In some embodiments, the determining whether the shopping lists have same and/or similar items comprises: obtaining, according to the shopping lists, item identification information of the items therein, and determining, according to the item identification information, whether the shopping lists have the same items; and/or obtaining, according to the shopping lists, basic item information of the items therein, wherein the basic item information comprises item name and/or item use, and determining, according to the basic item information, whether the shopping lists have similar items.

In some embodiments, the shopping status update information is geographic location update information, and the receiving, at the server, from the first smart shopping terminal and/or the second smart shopping terminal, shopping status update information associated with the respective shopping cart comprises: receiving, from the first smart shopping terminal and/or the second smart shopping terminal, first geographic location update information corresponding to the first smart shopping terminal and/or second geographic location update information corresponding to the second smart shopping terminal, respectively, and wherein the sending, at the server, to the second smart shopping terminal, shopping status update information for the shopping cart corresponding to the first smart shopping terminal and/or sending, at the server, to the first smart shopping terminal, shopping status update information for the shopping cart corresponding to the second smart shopping terminal comprises: sending, to the first smart shopping terminal and/or the second smart shopping terminal, the second geographic location update information and/or the first geographic location update information, respectively.

In some embodiments, the shopping status update information is payment list update information, and the receiving, at the server, from the first smart shopping terminal and/or the second smart shopping terminal, shopping status update information associated with the respective shopping cart comprises: receiving, from the first smart shopping terminal and/or the second smart shopping terminal, first payment list update information corresponding to the first smart shopping terminal and/or second payment list update information corresponding to the second smart shopping terminal, respectively, and wherein the sending, at the server, to the second smart shopping terminal, shopping status update information for the shopping cart corresponding to the first smart shopping terminal and/or sending, at the server, to the first smart shopping terminal, shopping status update information for the shopping cart corresponding to the second smart shopping terminal further comprises: sending, to the first smart shopping terminal and/or the second smart shopping terminal, the second payment list update information and/or the first payment list update information, respectively.

In some embodiments, the method further comprises: receiving a payment request from the first smart shopping terminal and/or the second smart shopping terminal; determining whether the payment is successful based on the first payment list update information and/or the second payment list update information and the payment request; and sending, to the first smart shopping terminal and/or the second smart shopping terminal, a response message indicating whether the payment is successful.

In some embodiments, the method further comprises at least one of: releasing the shopping group in response to the payment being successful; and releasing the shopping group in response to receiving, from the first smart shopping terminal and/or the second smart shopping terminal, a message indicating that the payment has been completed.

According to another aspect of the present disclosure, a server for managing a smart shopping terminal for a shopping cart is proposed. The server comprises: a processor; and a memory communicatively coupled to the processor, the memory storing instructions executable by the processor, the instructions, when executed by the processor, causing the processor to perform the methods as described above.

### BRIEF DESCRIPTION OF THE DRAWINGS

In order to more clearly illustrate the technical solutions in the embodiments of the present disclosure or the related art, the attached drawings, which are to be used in the descriptions of the embodiments or the related art, will be briefly described below. It is apparent that the attached drawings in the following descriptions are merely examples of the present disclosure, and other drawings may be obtained by those skilled in the art based on these drawings without creative efforts.

FIG. 1 is a flow chart showing an example of a shopping cart interaction method according to an embodiment of the present disclosure;

FIG. 2 is a structural diagram showing an example of a shopping cart interaction apparatus according to an embodiment of the present disclosure;

FIG. 3 is a structural diagram showing an example of a smart shopping terminal for a shopping cart or a server for managing a smart shopping terminal for a shopping cart according to an embodiment of the present disclosure; and

FIG. 4 is another structural diagram showing an example of a shopping cart interaction apparatus according to an embodiment of the present disclosure.

### DETAILED DESCRIPTION

To make the objectives, technical solutions, and advantages of the present disclosure clearer, the present disclosure will be further described in detail below in conjunction with the specific embodiments and with reference to the accompanying drawings.

It should be noted that all the expressions using “first” and “second” in the embodiments of the present disclosure are used to distinguish two different entities or different parameters having the same name, and therefore, “first” and “second” are merely for convenience of description, and should not be construed as limiting the embodiments of the present disclosure, which will not be further described in the following embodiments.

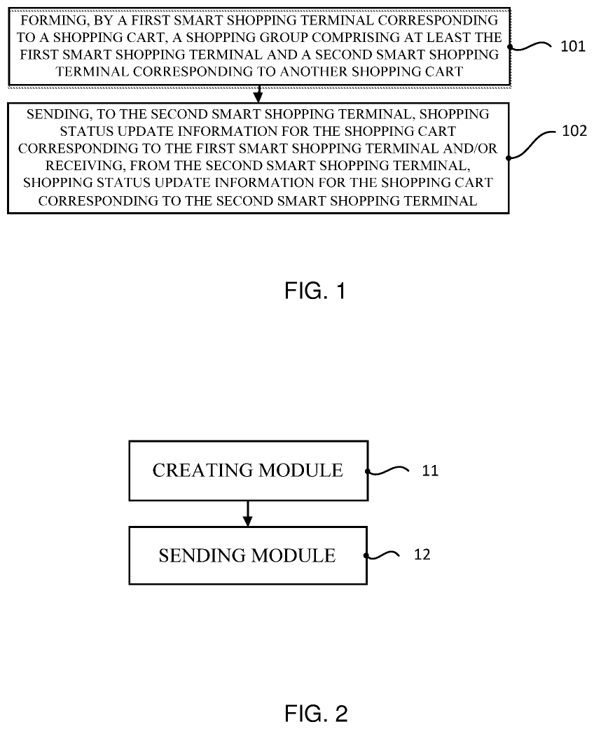

Referring to FIG. 1, which is a flow chart of a shopping cart interaction method according to an embodiment of the present disclosure, the shopping cart interaction method includes:

Step 101: creating a shopping group including at least two smart shopping terminals.

Step 102: sending shopping status update information for any of the smart shopping terminals in the shopping group to other smart shopping terminals in the shopping group.

In the above embodiment, a plurality of smart shopping terminals are set in the same shopping group, and each smart shopping terminal in the shopping group sends the shopping status update information on the terminal to other smart shopping terminals, so that the smart shopping terminals can know the information on other smart shopping terminals in the shopping group at any time, thereby realizing the interaction and information sharing among the smart shopping terminals in the shopping group. In this way, users who use the smart shopping terminals in the same shopping group can easily know the shopping situation of the family numbers and friends, which greatly increases the shopping pleasure and efficiency.

In some alternative embodiments, the creating a shopping group including at least two smart shopping terminals includes: receiving a shopping group creation request sent by any one of the smart shopping terminals and creating the shopping group, sending, to at least one of the other smart shopping terminals, a request for joining the shopping group, so that at least one of the other smart shopping terminals receives the request and joins the shopping group.

In the above embodiment, the user may perform the operation of creating a shopping group and inviting other smart shopping terminals to join the shopping group on any one of the smart shopping terminals. The shopping group may be directly created on the smart shopping terminal, or the shopping group may be created by the server and then the shopping group information may be returned to the smart shopping terminal. The request for joining the shopping group may be sent directly to other smart shopping terminals, or may be forwarded to other smart shopping terminals through the server.

Alternatively, the shopping cart interaction method further includes: obtaining identification information of at least one of the other smart shopping terminals, and generating the request for joining the shopping group according to the identification information. The identification information is the code of the smart shopping terminal. Each smart shopping terminal has unique identification information as the ID information of the smart shopping terminal. The identification information is stored in the server, and different shopping terminals can be distinguished by the identification information.

Alternatively, obtaining identification information of at least one of the other smart shopping terminals includes:

entering the identification information of at least one of the other smart shopping terminals at the smart shopping terminal; and/or scanning and identifying the identification information of at least one of the other smart shopping terminals by the smart shopping terminal, including by using a sensor or by scanning a code; and/or obtaining a smart shopping terminal list on the server, and selecting the identification information of at least one of the smart shopping terminals in the smart shopping terminal list. Alternatively, after the shopping group is created, the request for joining the shopping group is sent to at least one of the other smart shopping terminals within a preset range of the smart shopping terminal. Alternatively, the smart shopping terminal creates a shopping group and sets a shopping group password, and other smart shopping terminals can directly join the shopping group by inputting the same shopping group password. In addition, after the shopping group is successfully created, other smart shopping terminals may apply to join the shopping group by identifying the identification information of any smart shopping terminal in the shopping group, and any smart shopping terminal in the shopping group may exit the shopping group at any time.

As can be seen from the above embodiments, the shopping cart interaction method provided by the embodiments of the present disclosure implements the creation of a shopping group by various methods, and is applicable to a plurality of different situations. When in use, the user can conveniently add the smart shopping terminals used by family members and friends to the same shopping group, so as to realize the interaction and data sharing among the smart shopping terminals in the same shopping group in the subsequent shopping process.

In some embodiments of the present disclosure, the shopping status update information is shopping list update information, and the sending shopping status update information for any of the smart shopping terminals in the shopping group to other smart shopping terminals in the shopping group includes: receiving the shopping list update information on any of the smart shopping terminals in the shopping group, and sending the shopping list update information to any other smart shopping terminal in the shopping group, so that any other smart shopping terminal in the shopping group updates the shopping lists according to the shopping list update information.

In the above embodiment, when the shopping list for any of the smart shopping terminals in the shopping group changes, the smart shopping terminal generates the shopping list update information for the smart shopping terminal according to the change of the shopping list and sends the shopping list update information to any other smart shopping terminal in the shopping group. In this way, the sharing of the shopping list information in the group is realized, so that each shopping member in the shopping group can view the shopping list in the group at any time, and confirm the information of the items that need to be purchased.

Alternatively, the shopping cart interaction method further includes: receiving a shopping list update request from any of the smart shopping terminals in the shopping group, obtaining the corresponding shopping list update information according to the shopping list update request, and sending the information to the requesting smart shopping terminal. In a specific embodiment, if a smart shopping terminal wants to know the shopping situation of other smart shopping terminals in the same shopping group, it may send the shopping list update request to other smart shopping terminals directly or through the server, and the other smart shopping terminals, after receiving the shopping list update request, send, respectively, the shopping list information on the respective terminals to the requesting smart shopping terminal, so that the requesting smart shopping terminal can know the complete shopping lists in the group.

Alternatively, after the smart shopping terminal obtains the complete shopping lists in the group, the method further includes: determining whether the shopping lists have the same or similar items; and if the same or similar items are present in the shopping lists, determining whether the items are derived from different smart shopping terminals; and if the items are derived from different smart shopping terminals, highlighting the items to remind the user to determine whether the corresponding items need to be deleted. The determining whether the shopping lists have the same or similar items includes: obtaining item ID information according to the shopping lists; and determining, according to the item ID information, whether the shopping lists have the same items; and obtaining, according to the shopping lists, basic item information, wherein the basic item information includes item name, item use and the like, and determining, according to the basic item information, whether the shopping lists have similar items. The item ID information is unique identification information of the item, and it is possible to distinguish whether two items are the same based on the item ID information. For the same kind of items of different brands, for example, the laundry detergents of different brands, they have different item ID information, and in this case, two items can be judged to be similar items according to the item name. For items having similar uses, such as laundry detergents and washing powders, they can be judged as similar items by item use.

It can be seen from the above embodiment that the shopping cart interaction method provided by the embodiment of the present disclosure filters out the same or similar items according to the shopping lists, and prompts the user for the same or similar items, so that the user can choose whether to delete the items according to the prompt. The user can confirm the shopping list in time, so as to avoid multiple users buying unnecessary duplicate or similar items when shopping separately.

In other embodiments of the present disclosure, the shopping status update information is geographic location update information, and the sending shopping status update information for any of the smart shopping terminals in the shopping group to other smart shopping terminals in the shopping group includes: receiving the geographic location update information for any of the smart shopping terminals in the shopping group, and sending the geographic location update information to any other smart shopping terminal in the shopping group, so that any other smart shopping terminal in the shopping group obtains the geographic location of the smart shopping terminal according to the geographic location update information. When the geographic location of any of the smart terminals in the shopping group changes, the smart terminal generates the geographic location update information for the smart terminal according to the change of the geographical location, and send the information to other smart shopping terminals directly or through the server.

It can be seen from the above embodiments that the shopping cart interaction method provided by the embodiments of the present disclosure enables the user to know the locations of the families or friends at any time during or at the end of the shopping process through the location sharing of each smart shopping cart, so that the user can quickly find his/her families or friends, which is especially suitable for the case in which the elderly or children shop together.

In other embodiments of the present disclosure, the shopping status update information is payment list update information, and the sending shopping status update information for any of the smart shopping terminals in the shopping group to other smart shopping terminals in the shopping group includes: receiving the payment list update information for any of the smart shopping terminals in the shopping group, and sending the payment list update information to any other smart shopping terminal in the shopping group, so that any other smart shopping terminal in the shopping group updates the payment lists according to the payment list update information and makes payment based on the payment lists. After the shopping is completed, the user may choose to pay separately at each smart shopping terminal or to pay uniformly. If the user chooses to pay separately, each smart shopping terminal in the shopping group separately settles the items in the corresponding shopping cart and returns the payment information to the server. If the user chooses to pay uniformly, the user selects any one of the smart shopping terminals in the shopping group, and the payment lists on other smart shopping terminals in the group are sent to the selected smart shopping terminal. The selected smart shopping terminal receives the payment lists and makes payment according to the payment lists; after the payment is completed, the payment information is returned to the server and the shopping group is released. The user may actively release the shopping group, or after the payment is successful, the server automatically releases the shopping group, which is convenient for other users to use.

It can be seen from the above embodiment that the shopping cart interaction method provided by the embodiment of the present disclosure can update the payment lists in the shopping group at any time. After the shopping is completed, through the sharing of the payment lists, the user may choose to pay separately or to pay uniformly according to specific needs. When the user chooses to pay uniformly, the user can uniformly pay for the items purchased in different shopping carts, which is convenient and quick, and greatly enhances the shopping experience.

A more specific embodiment is provided below to illustrate the shopping cart interaction method of the embodiments of the present disclosure. For the sake of understanding, the smart shopping terminal A and the smart shopping terminal B are taken as an example. In the more specific embodiment, the shopping cart interaction method includes:

Step 201: when two people start shopping, the smart shopping terminal A creates a shopping group and sends a request for joining the shopping group to the smart shopping terminal B.

Step 202: the smart shopping terminal B receives the request and joins the shopping group.

Step 203: during the shopping process, the smart shopping terminal A and the smart shopping terminal B respectively use the respective item identification units on the smart shopping terminals to identify the information and quantity of the purchased items to form their own shopping lists.

Step 204: when the smart shopping terminal A or the smart shopping terminal B needs to know the information of the items purchased by the other shopping terminal, it initiates, by the wireless communication module on the terminal, a request to the server to apply for viewing the shopping list of the other shopping terminal.

Step 205: the server receives the request, and sends the shopping list of the smart shopping terminal A or the smart shopping terminal B to the other shopping terminal and displays it on the interactive interface of the terminal. If there are multiple pieces of item information that are duplicate, the system highlights the information and prompts the user whether they needs to be deleted.

Step 206: during the shopping process or after the shopping is completed, if the smart shopping terminal A or the smart shopping terminal B needs to find the other shopping terminal, the location information of the other shopping terminal may be found through the interactive interface. The positioning may be achieved via Bluetooth or WIFI or visible light communication, and the communication may use WIFI.

Step 207: after the shopping is completed, the smart shopping terminals A and B generate respective payment lists and send them to the server. If the user chooses to pay separately at the two smart shopping terminals, the payment is made on the respective smart shopping terminals, and the payment information is returned to the server after payment; if the user chooses to pay uniformly, the server sends the payment list to the smart shopping terminal A or the smart shopping terminal B, and the unified payment is performed at the smart shopping terminal A or the smart shopping terminal B.

Step 208, after the payment is completed, the shopping group is released.

The above embodiment provides a shopping group with only two smart terminals. During the shopping process, the smart shopping terminal A and the smart shopping terminal B join to the same shopping group, and the interaction and data sharing between the two smart shopping terminals is realized in the shopping group. The shopping cart interaction method described in this embodiment is also applicable to the case of three or more smart shopping terminals.

In other alternative embodiments, the shopping status update information for any of the smart shopping terminals in the shopping group is sent to the server for storage, and when the server receives the acquisition request sent by any of the smart shopping terminals in the shopping group, the server sends the shopping status update information to the corresponding smart shopping terminal. As some alternative embodiments, the server sends the shopping status update information to any of the smart shopping terminals in the shopping group in real time; and/or the server sends the shopping status update information to any of the smart shopping terminals in the shopping group at predetermined time intervals; and/or the server sends the shopping status update information to any of the smart shopping terminals in the shopping group when the shopping status update information changes.

A second aspect of the embodiments of the present disclosure provides a shopping cart interaction apparatus. Referring to FIG. 2, the shopping cart interaction apparatus includes the following modules.

The creating module 11 is configured to create a shopping group including at least two smart shopping terminals.

Alternatively, the creating module 11 is further configured to: receive a shopping group creation request sent by any one of the smart shopping terminals and create the shopping group, send, to at least one of the other smart shopping terminals, a request for joining the shopping group, so that at least one of the other smart shopping terminals receives the request and joins the shopping group.

Alternatively, it is further configured to: obtain identification information of at least one of the other smart shopping terminals, and generate the request for joining the shopping group according to the identification information. The obtaining includes: entering the identification information of at least one of the other smart shopping terminals at the smart shopping terminal; and/or scanning and identifying the identification information of at least one of the other smart shopping terminals by the smart shopping terminal; and/or obtaining a smart shopping terminal list on the server, and selecting the identification information of at least one of the smart shopping terminals in the smart shopping terminal list.

The sending module 12 is configured to send shopping status update information for any of the smart shopping terminals in the shopping group to other smart shopping terminals in the shopping group.

Alternatively, the shopping status update information is shopping list update information, and the sending module 12 is further configured to: receive the shopping list update information on any of the smart shopping terminals in the shopping group, and send the shopping list update information to any other smart shopping terminal in the shopping group, so that any other smart shopping terminal in the shopping group updates the shopping lists according to the shopping list update information.

Alternatively, the shopping status update information is geographic location update information, and the sending module 12 is further configured to: receive the geographic location update information for any of the smart shopping terminals in the shopping group, and send the geographic location update information to any other smart shopping terminal in the shopping group, so that any other smart shopping terminal in the shopping group obtains the geographic location of the smart shopping terminal according to the geographic location update information.

Alternatively, the shopping status update information is payment list update information, and the sending module 12 is further configured to: receive the payment list update information for any of the smart shopping terminals in the shopping group, and send the payment list update information to any other smart shopping terminal in the shopping group, so that any other smart shopping terminal in the shopping group updates the payment lists according to the payment list update information and makes payment based on the payment lists.

In can be seen from the above embodiment that, in the shopping cart interaction apparatus provided by the embodiments of the present disclosure, a plurality of smart shopping terminals are set in the same shopping group, and each smart shopping terminal in the shopping group sends the shopping status update information on the terminal to other smart shopping terminals, so that the smart shopping terminals can know the information on other smart shopping terminals in the shopping group at any time, thereby realizing the interaction and information sharing among the smart shopping terminals in the shopping group. In this way, users who use the smart shopping terminals in the same shopping group can easily know the shopping situation of the family numbers and friends, which greatly increases the shopping pleasure.

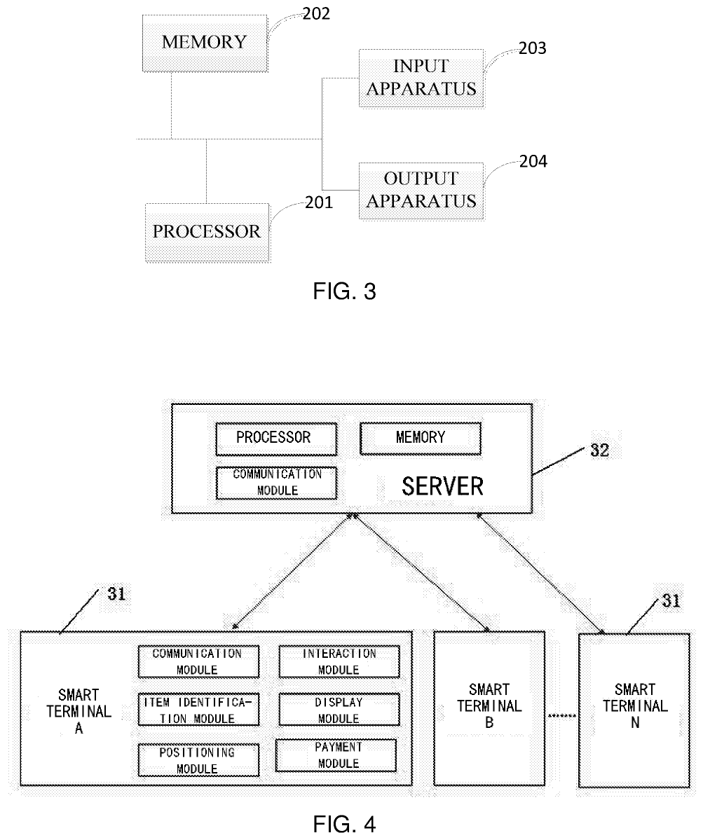

A third aspect of the embodiments of the present disclosure provides an electronic device that can be used as a smart shopping terminal for a shopping cart and/or a server for managing a smart shopping terminal for the shopping cart. Referring to FIG. 3, the electronic device may include:

at least one processor 201 and a memory 202, and one processor 201 are taken as an example in FIG. 3.

The electronic device may also include: an input apparatus 203 and an output apparatus 204.

The processor 201, the memory 202, the input apparatus 203, and the output apparatus 204 may be connected by a bus or by other ways. In FIG. 3, a bus connection is taken as an example.

The memory 202 is a non-volatile computer readable storage medium, and may be used for storing non-volatile software programs, non-volatile computer-executable programs and modules, such as the program instructions/modules corresponding to the method of operating a smart shopping terminal for a shopping cart and/or the method of managing the smart shopping terminal for the shopping cart as described in the embodiments of the present disclosure. By executing the non-volatile software programs, instructions, and modules stored in the memory 202, the processor 201 performs various functional applications and data processing of the server, that is, implements the methods in the foregoing method embodiments.

The memory 202 may include a program storage area and a data storage area, wherein the program storage area may store operating systems, application programs required for at least one function; and the data storage area may store data created according to usage of the electronic device, and the like. Moreover, the memory 202 may include high speed random access memory, and may also include non-volatile memory, such as at least one magnetic disk storage device, flash memory device, or other non-volatile solid state storage device. In some embodiments, the memory 202 may alternatively include storages remotely located relative to the processor 201, and the remote storages may be connected to the electronic device over networks. Examples of such networks include, but are not limited to, the Internet, intranets, local area networks, mobile communication networks, and combinations thereof.

The input apparatus 203 may receive input numeric or character information and generate signal inputs related to user settings and function control of the electronic device. The output apparatus 204 may include a display device such as a display screen.

The one or more modules are stored in the memory 202 and, when executed by the one or more processors 201, perform any one or more of the various methods of any of the above-described method embodiments.

In one embodiment of the present disclosure, as shown in FIG. 4, the smart shopping terminal 31 may include an interaction unit, a display unit, an item identification unit, a positioning unit, a communication unit, and a payment unit. The interaction unit is configured to initiate a shopping group creation function, initiate a data acquisition acquisition request, and display related information; the display unit is configured to display the information about the shopping cart and the items; the item identification unit is configured to identify the information of purchased items; the positioning unit is configured to obtain the location information of the shopping cart; the payment unit is configured to make payment after the shopping is completed; and the communication unit is configured to implement information interaction between the smart terminal and the server.

The server 32 includes a memory, a processor, and a communication unit, where the memory is configured to store identification information, geographic location information, shopping list information, payment list information, item information of the smart shopping terminals, and the like; the processor is configured to perform shopping list calculation and the data processing in the interaction with the smart shopping terminals; the communication unit is configured to implement information interaction between the server and the smart shopping terminal.

It should be understood by those of ordinary skill in the art that the discussion of any of the above embodiments is only exemplary, and is not intended to suggest that the scope of the present disclosure (including the claims) is limited to these examples; in the concept of the present disclosure, the technical features in the above single embodiment or the technical features in different embodiments may also be combined, the steps may be implemented in any order, and there are many other changes in different aspects of the present disclosure as described above, which are not provided in detail for the sake of simplicity.

In addition, well known power/ground connections to integrated circuit (IC) chips and other components may or may not be shown in the provided figures for simplicity of illustration and discussion, and in order not to obscure the present disclosure. Furthermore, the apparatus may be shown in block diagram form in order to avoid obscuring the present disclosure, and this also contemplates the fact that the details of the embodiments of the apparatus in the form of a block diagram are highly dependent on the platform on which the present disclosure is to be implemented (that is, these details should be fully understood by those skilled in the art). In the case of illustrating specific details (for example, circuits) to describe exemplary embodiments of the present disclosure, it will be apparent to those skilled in the art that the disclosure may be implemented in the absence of these specific details or in the event of changes in these specific details. Accordingly, the description is to be considered as illustrative rather than restrictive.

Although the present disclosure has been described in connection with the specific embodiments of the present disclosure, according to the previous description, many alternatives, modifications and variations of these embodiments will be apparent to those skilled in the art. For example, other memory architectures (for example, dynamic RAM (DRAM)) may be used in the embodiments discussed.

Embodiments of the present disclosure are intended to cover all such alternatives, modifications and variants falling within the broad scope of the attached claim. Therefore, any omissions, modifications, equivalents, improvements, and the like, which are made within the spirit and scope of the present disclosure are intended to be included within the scope of the present disclosure.

1. A method of operating a smart shopping terminal for a shopping cart, the method comprising:
forming, by a first smart shopping terminal corresponding to the shopping cart, a shopping group comprising at least the first smart shopping terminal and a second smart shopping terminal corresponding to another shopping cart; and
performing at least one of: sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal.

2. The method of claim 1, wherein the forming, by a first smart shopping terminal corresponding to the shopping cart, a shopping group comprising at least the first smart shopping terminal and a second smart shopping terminal corresponding to another shopping cart comprises:
creating the shopping group at the first smart shopping terminal;
sending, to the second smart shopping terminal, a request for joining the shopping group; and
receiving a response indicating whether the second smart shopping terminal is to join the shopping group.

3. The method of claim 2, wherein the sending, to the second smart shopping terminal, a request for joining the shopping group comprises: sending, to a server, a request to invite the second smart shopping terminal to join the shopping group, and
the receiving a response indicating whether the second smart shopping terminal is to join the shopping group comprises: receiving, from the server, a response indicating whether the second smart shopping terminal is to join the shopping group.

4. The method of claim 1, wherein the forming, by a first smart shopping terminal corresponding to the shopping cart, a shopping group comprising at least the first smart shopping terminal and a second smart shopping terminal corresponding to another shopping cart comprises:
receiving a request for joining a shopping group from the second smart shopping terminal or a server; and
based on a user operation at the first smart shopping terminal, sending, to the second smart shopping terminal or the server, a response indicating whether the first smart shopping terminal is to join the shopping group.

5. The method of claim 2, wherein the request for joining the shopping group is generated based on identification information of the second smart shopping terminal.

6. The method of claim 5, wherein the identification information of the second smart shopping terminal is obtained by at least one of:
entering the identification information of the second smart shopping terminal at the first smart shopping terminal;
scanning and identifying the identification information of the second smart shopping terminal by the first smart shopping terminal; and
obtaining a smart shopping terminal list on the server, and selecting the identification information of the second smart shopping terminal in the smart shopping terminal list.

7. The method of claim 1, wherein the shopping status update information is shopping list update information, and the performing at least one of: sending, to the second smart shopping terminal, shopping status update information for the shopping cart corresponding to the first smart shopping terminal or receiving, from the second smart shopping terminal, shopping status update information for the shopping cart corresponding to the second smart shopping terminal comprises:
receiving, from the second smart shopping terminal, second shopping list update information corresponding to the second smart shopping terminal,
sending, to the second smart shopping terminal, first shopping list update information corresponding to the first smart shopping terminal, and
updating the shopping lists according to the first shopping list update information and the second shopping list update information.

8. The method of claim 7, further comprising:
receiving, from the second smart shopping terminal, a shopping list update request,
determining corresponding shopping list update information according to the shopping list update request; and
sending, to the second smart shopping terminal, the shopping list update information.

9. The method of claim 7, further comprising:
determining whether the shopping lists have at least one of same items or similar items;
in response to determining that at least one of the same items or similar items are present in the shopping lists, determining whether the items are available from different smart shopping terminals; and
in response to determining that the items are available from different smart shopping terminals, outputting a prompt indicating presence of the same or similar items in the shopping lists.

10. The method of claim 9, wherein the determining whether the shopping lists have at least one of same items or similar items comprises at least one of:
obtaining, according to the shopping lists, item identification information of the items therein, and determining, according to the item identification information, whether the shopping lists have the same items; or
obtaining, according to the shopping lists, basic item information of the items therein, wherein the basic item information comprises at least one of item name or item use, and determining, according to the basic item information, whether the shopping lists have similar items.

11. The method of claim 1, wherein the shopping status update information is geographic location update information, and the performing at least one of: sending, to the second smart shopping terminal, shopping status update information for the shopping cart corresponding to the first smart shopping terminal or receiving, from the second smart shopping terminal, shopping status update information for the shopping cart corresponding to the second smart shopping terminal comprises:
receiving, from the second smart shopping terminal, second geographic location update information corresponding to the second smart shopping terminal,
sending, to the second smart shopping terminal, first geographic location update information corresponding to the first smart shopping terminal, and
outputting, according to the first geographic location update information and the second geographic location update information, indication information indicating a geographical location of the second smart shopping terminal relative to the first smart shopping terminal.

12. The method of claim 1, wherein the shopping status update information is payment list update information, and the performing at least one of: sending, to the second smart shopping terminal, shopping status update information for the shopping cart corresponding to the first smart shopping terminal and/or receiving, from the second smart shopping terminal, shopping status update information for the shopping cart corresponding to the second smart shopping terminal further comprises:
receiving, from the second smart shopping terminal, second payment list update information corresponding to the second smart shopping terminal;
sending, to the second smart shopping terminal, first payment list update information corresponding to the first smart shopping terminal; and
updating payment lists based at least on the first payment list update information and the second payment list update information.

13. The method of claim 12, further comprising:
making payment based on the payment lists.

14. The method of claim 13, further comprising at least one of:
releasing or exiting the shopping group after the payment is completed at the first smart shopping terminal; or
releasing or exiting the shopping group in response to receiving, from the second smart shopping terminal, a message indicating that the payment has been completed.

15. A smart shopping terminal for a shopping cart, the smart shopping terminal comprising:
a processor; and
a memory communicatively coupled to the processor, the memory storing instructions executable by the processor, the instructions, when executed by the processor, causing the processor to perform the method of claim 1.

16. A method of managing a smart shopping terminal for a shopping cart, the method comprising:
forming, at a server, a shopping group comprising at least a first smart shopping terminal corresponding to a first shopping cart and a second smart shopping terminal corresponding to a second shopping cart;
receiving, at the server, from the first smart shopping terminal and/or the second smart shopping terminal, shopping status update information associated with the respective shopping cart; and
performing at least one of: sending, at the server, to the second smart shopping terminal, shopping status update information for the shopping cart corresponding to the first smart shopping terminal or sending, at the server, to the first smart shopping terminal, shopping status update information for the shopping cart corresponding to the second smart shopping terminal.

17. The method of claim 16, wherein the forming, at a server, a shopping group comprising at least a first smart shopping terminal corresponding to a first shopping cart and a second smart shopping terminal corresponding to a second shopping cart comprises:
receiving, from the first smart shopping terminal, a request instructing the second smart shopping terminal to join the shopping group;
sending the request to the second smart shopping terminal;
receiving, from the second smart shopping terminal, a response indicating whether the second smart shopping terminal is to join the shopping group; and
sending the response to the first smart shopping terminal.

18. The method of claim 16, wherein the forming, at a server, a shopping group comprising at least a first smart shopping terminal corresponding to a first shopping cart and a second smart shopping terminal corresponding to a second shopping cart comprises:
creating a shopping group at the server;
sending a request for joining the shopping group to the first smart shopping terminal and the second smart shopping terminal; and
receiving, from the first smart shopping terminal and the second smart shopping terminal, respectively, responses indicating whether the respective smart shopping terminals are to join the shopping group.

19. The method of claim 18, wherein the request for joining the shopping group is generated based on identification information of the first smart shopping terminal and the second smart shopping terminal.

20-27. (canceled)

28. A server for managing a smart shopping terminal for a shopping cart, comprising:
a processor; and
a memory communicatively coupled to the processor, the memory storing instructions executable by the processor, the instructions, when executed by the processor, causing the processor to perform the method of claim 16.
